(19) United States
(12) Patent Application Publication
(10) Pub. No.: US 2005/0274558 A1
(43) Pub. Date: Dec. 15, 2005

(54) ELECTRIC VEHICLE

(75) Inventor: Takayuki Atsumi, Mori-machi (JP)

Correspondence Address: ERNEST A. BEUTLER, ATTORNEY AT LAW, 10 RUE MARSEILLE, NEWPORT BEACH, CA, 92660, US

(73) Assignee: KABUSHIIKI KAISHA MORIC, Mori-Machi (JP)

(21) Appl. No.: 10/908,085

(22) Filed: Apr. 27, 2005

(30) Foreign Application Priority Data
May 27, 2004 (JP) 2004-138346

(51) Int. Cl. B60K 31/00

(52) U.S. Cl. 180/170

(57) ABSTRACT

A vehicle speed determining arrangement for a vehicle driven by an electric motor wherein an actual speed sensor is not required and the vehicle speed is determined by measuring the actual current flow through the motor.

### BACKGROUND OF INVENTION

This invention relates to an electrically driven vehicle and more particularly to an improved and simplified vehicle speed control and particularly to one powered by a shunt motor.

A wide variety of vehicles are provided with electric motors as a power source as a prime mover therefore. For example, as shown in Japanese Published Patent Application Hei 10-309005 (A) it has been proposed to employ a DC shunt motor for the driving of electric powered vehicles such as golf carts or other vehicles. There the armature coil and the field coil are connected in parallel to a common electric power source. As is known, it is possible to energize the armature coil and the field coil independently from each other. The amount of current supplied to the armature coil is controlled based on the position of a operator controlled vehicle speed control such as, for example, an accelerator pedal. Then a specific current is supplied to the field coil depending on the armature current value. This is generally done by reference to a field map that is constant or pre-designed for each motor. This produces a specific torque from the electric motor to control the operation required by the various operating conditions of the electric vehicle.

One type of control employed is effective to limit the speed of the vehicle so that a specific speed will not be exceeded, regardless of the operator demand. Alternately or additionally torque is generated in the motor, and the motor can be driven and controlled depending on the operating conditions.

In an electric vehicle such as a golf car, the vehicle speed is detected, and the motor driving current is controlled to regeneratively brake the motor when the vehicle speed exceeds a speed limit and/or the current to the field coil relative to the current to the armature coil is changed depending on the vehicle speed for controlling the motor driving current so that the motor can be optimally controlled depending on the vehicle speed.

With arrangements of this type, it is therefore necessary to determine the actual vehicle speed. This is generally done by calculating the vehicle speed by measuring pulses from an encoder provided in the motor or from pulses generated by a projection or a magnet, provided on a driven component of the vehicle such as a drive or axle shaft. This adds to the cost and complicates construction.

It is therefore a principal object of the invention to provide an improved and simplified manner for detecting the traveling speed of an electric motor driven vehicle.

### SUMMARY OF THE INVENTION

A first feature of the invention is adapted to be embodied in a speed sensor for a vehicle driven by an electrical motor. A control outputs a driving current to the electric motor. A current sensor detects the current flow through the electric motor and a calculator determined the vehicle speed from the measured current.

In accordance with a further characteristic of this first feature, the electric motor is a shunt motor having field and armature coils and the current to these coils is controlled by the control.

A second feature of the invention is adapted to be embodied in determining the speed of a vehicle driven by an electrical motor. In accordance with this method, the driving current to the motor is controlled. The current flow through the coil detected and the vehicle speed determined from the measured current.

In accordance with a further characteristic of this second feature, the electric motor is a shunt motor having field and armature coils and the current to these coils is controlled.

### BRIEF DESCRIPTION OF THE DRAWINGS

FIG. 1 is a partially schematic top elevational view of an electric powered vehicle constructed and operated in accordance with the invention.

FIG. 2 is a schematic electrical diagram of the vehicle and its control.

FIG. 3 is a graphical view of the relation of the current in the coils.

### DETAILED DESCRIPTION

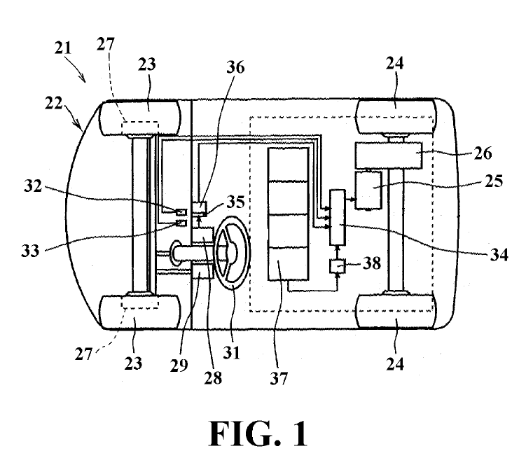

Referring now in detail to the drawings and initially to FIG. 1, an electrically powered vehicle such as a golf cart, as an example of vehicle with which the invention may be practiced is identified generally by the reference numeral 21. This golf cart 21 is provided with a body, frame 22 that rotatably supports in any desired manner paired front wheels 23 and rear wheels 24. In the illustrated embodiment, the rear wheels 24 are driven by a shunt type electric motor 25 through a transmission 26. Associated with some or all of the wheels 23 and 24 (only the front wheels 23 in the illustrated embodiment) are brakes 27 of any desired type.

An operator may be seated on a suitable seat (neither of which are shown) behind an accelerator pedal 28, for controlling the speed of the electric motor 25, a brake pedal 29, for operating the wheel brakes 27, and a steering wheel 31, for steering the front wheels 23 in any desired manner.

Also juxtaposed to the operator's position is a main switch 32, and a direction control switch 33, for controlling the direction of travel of the golf cart 21 by controlling the direction of rotation of the motor 25. The main switch 32 and the direction control switch 33 are connected to a controller 34. Operation of the accelerator pedal 28 is transmitted to an on off pedal switch 35 and an accelerator opening degree sensor 36 connected to the controller 34, to send on or off state of the accelerator 28 and its degree of opening to the controller 34.

A plurality of batteries 37 (48 V in total, for example) as power sources are mounted suitably on the body frame 22 and are connected through a relay 38 to the controller 34.

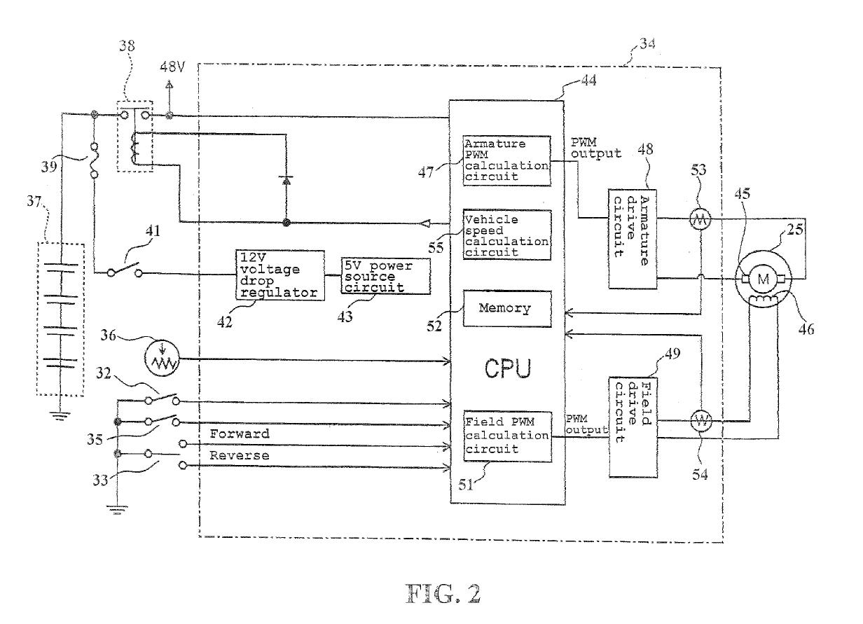

Referring now to FIG. 2 this is a circuit block diagram of the electric vehicle 21 using the shunt motor 25 and embodying the invention. The supply voltage is supplied to the shunt motor 25 for driving the vehicle 21 and the controller 34 for driving and controlling the shunt motor 25 from the batteries 37. The supply voltage (48 V) from the batteries 37 is supplied to the shunt motor 25 via the relay 38 and to the controller 34 via a fuse 39 and a towing switch 41. The towing switch 41 is used to stop the supply of power to the controller 34 when necessary such as when the vehicle is towed and the operation of an automatic brake circuit is stopped. The supply voltage from the battery 37 is converted to 5 V by a voltage regulator 42 and a 5V power source circuit 43 in the controller 34 and then supplied to calculation circuits and drive circuits in the controller 34 which will be described shortly.

Signals from the main switch 11, the accelerator pedal switch 12, the direction change shift switch 13 and the accelerator opening sensor 14 are inputted into a CPU 44. The CPU 44 controls to drive the shunt motor 25 based on these signals.

The shunt motor 25 has an armature coil 45 and a field coil 46. A command current is calculated in an armature PWM calculation circuit 47 of the CPU 44 is applied to the armature coil 45 via an armature drive circuit 48. In this case, the command current is a PWM signal indicating the percentage (%) of the drive pulse width and a driving current is supplied to the armature coil 45 according to the PWM (%) command.

The armature drive circuit 48 consists of, by way of example, a bipolar circuit containing two arrays of eight FETs, and the arrays of FETs are alternately switched on and off to apply the driving current to the armature coil 45.

A field drive circuit 49 consisting of, by way of example, an H-bridge circuit having four FETs effects changes in the direction of current by switching obliquely paired two FETs on or off simultaneously.

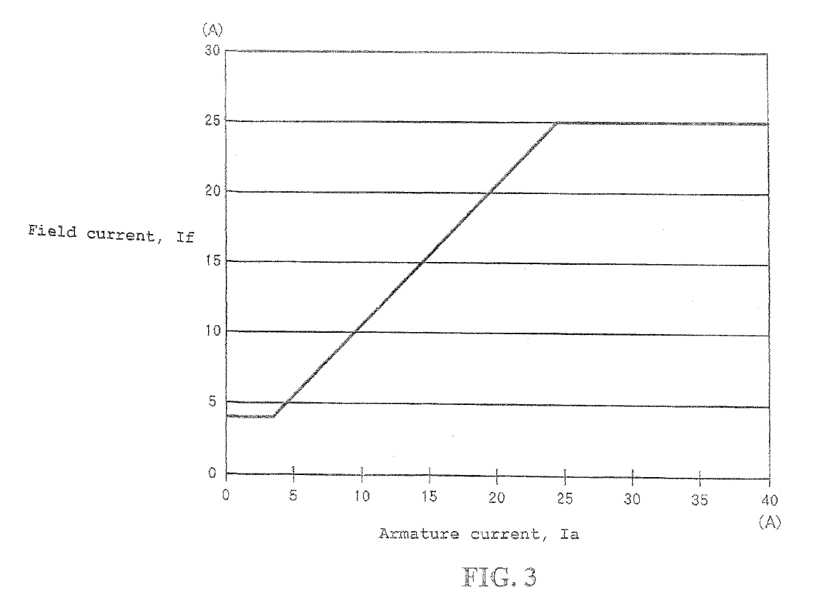

A command current calculated in a field PWM calculation circuit 51 of the CPU 44 is applied to the field coil 46 via a field drive circuit 49. The command signal for the field coil 46 is calculated based on an Ia-If map, as shown in FIG. 3, is stored in the memory 52. The Ia-If map is a map showing the field current (If) to the armature current (Ia) at which the motor is driven at the maximum degree of efficiency based upon the motor characteristics.

As with the armature current, the command signal for the field current is a PWM signal indicating the percentage (%) of the drive pulse width. A driving current is supplied to the field coil 46 according to the PWM (%) command.

The current which actually flows through the armature coil 45 is detected by a current sensor 53 and the command signal to the armature coil 45 is feedback-controlled. The current which actually flows through the field coil 46 is detected by a current sensor 54 and the command signal to the field coil 46 is feedback-controlled.

The CPU 44 has a vehicle speed calculation circuit 55. The vehicle speed calculation circuit 55 calculates the vehicle speed based on a detection value from the armature current sensor 53 for the armature coil 45 in the manner now to be described.

This methodology is based on the principle that the motor shaft angular speed is proportional to the counter electromotive voltage. The proportionality constant is a counter electromotive voltage constant. The motor angular speed w is calculated based on the following equations:
Vᵣ=Kᵥ×ω
e^{o}=V_{B}×DUTY
e^{o}=Rₘ×Iₘ+Kᵥ×ω.
Thus,
ω=Vᵣ/Kᵥ=(V_{B}×DUTY−Rₘ×Iₘ)/Kᵥ
where
   Vᵣ: counter electromotive voltage (V),
   e^{o}: voltage applied to the motor (V),
   Rₘ: equivalent resistance of the motor (Ω),
   Iₘ: motor current (armature coil current) (A),
   Kᵥ: counter electromotive voltage constant (V/rad/s) (Kᵥ is proportional to the field current If.),
   ω: motor angular speed (rad/s),
   V_{B}: battery voltage (V), and
   DUTY: PWM command value (%).

Once the motor angular speed is obtained, the vehicle speed is can be calculated based on the mechanical transmission characteristics from the motor to the axle and tire which can be calculated in advance and is constant.

Thus from the foregoing description it should be readily apparent to those skilled in the art that a simplified method and structure for determining the vehicle speed for a variety of purposes is possible without requiring separate sensors or detectors and thus simplifying the construction and reducing costs. Of course those skilled in the art will readily understand that the described embodiments are only exemplary of forms that the invention may take and that various changes and modifications may be made without departing from the spirit and scope of the invention, as defined by the appended claims.

1. A vehicle and speed sensor, said vehicle being driven by an electrical motor, a control outputting a driving current to said motor, a current sensor detecting the current flow through the said and a calculator determined the speed of said vehicle from the measured current.

2. A vehicle and speed sensor as set forth in claim 1 wherein the electric motor is a shunt motor having field and armature coils and the current to these coils is controlled by the control.

3. A vehicle and speed sensor as set forth in claim 2 wherein the control outputs driving currents to the armature coil and the field coil of the shunt motor and the current flow is detected by current sensors for detecting the currents flowing through said armature coil and said field coil, performs feedback control of the motor driving currents.

4. A vehicle and speed sensor as set forth in claim 3 wherein the calculator comprises a vehicle speed calculation circuit for calculating the vehicle speed based on the current values detected by the current sensors.

5. A vehicle and speed sensor as set forth in claim 4 wherein the vehicle speed calculation circuit calculates the motor angular speed based on the counter electromotive voltage of the motor.

6. A vehicle and speed sensor as set forth in claim 5 wherein the angular speed wherein the angular speed ω is calculated from the counter electromotive voltage Vᵣ of the motor and a counter electromotive voltage constant Kᵥ based on the equations: ω=Vᵣ/Kᵥ=(V_{B}×DUTY−Rₘ×Iₘ)/Kᵥ where V_{B} is the battery voltage, DUTY is a PMW command value for the motor current, Iₘ is the current value in the armature coil of the motor, and Rₘ is the equivalent resistance of the motor.

7. A method for determining the speed of a vehicle driven by an electrical motor in which the driving current to the motor is controlled, said method comprising determining the current flow through the motor and determining the vehicle speed from the measured current.

8. The method of claim 7 wherein the electric motor is a shunt motor having field and armature coils and the current to these coils is controlled for operating the motor.

9. The method of claim 8 wherein the driving currents to the armature coil and the field coil of the shunt motor are controlled and the current flow is detected by detecting the currents flowing through the armature coil and the field coil, feedback control of the motor driving currents is performed.

10. The method of claim 9 wherein a vehicle speed calculation circuit for calculating the vehicle speed based on the current values detected by the current sensors.

11. The method of claim 10 wherein the vehicle speed calculation is done by calculating the motor angular speed based on the counter electromotive voltage of the motor.

12. The method of claim 11 wherein the angular speed ω is calculated from the counter electromotive voltage Vᵣ of the motor and a counter electromotive voltage constant Kᵥ based on the equations: ω=Vᵣ/Kᵥ=(V_{B}×DUTY−Rₘ×Iₘ)/Kᵥ where V_{B} is the battery voltage, DUTY is a PMW command value for the motor current, Iₘ is the current value in the armature coil of the motor, and Rₘ is the equivalent resistance of the motor.
